(19) United States
(12) Patent Application Publication
(10) Pub. No.: US 2013/0020970 A1
(43) Pub. Date: Jan. 24, 2013

(54) Control System and Control Method for Electric Bicycle

(71) Applicants: Wenbo Zhang, Shanghai (CN); Wenhua Cui, Shanghai (CN); Wei Zhang, Shanghai (CN)

(72) Inventors: Wenbo Zhang, Shanghai (CN); Wenhua Cui, Shanghai (CN); Wei Zhang, Shanghai (CN)

(73) Assignee: O2Micro, Inc., Santa Clara, CA (US)

(21) Appl. No.: 13/542,386

(22) Filed: Jul. 5, 2012

(30) Foreign Application Priority Data
Jul. 18, 2011 (CN) 201110204408.7

(51) Int. Cl. B60L 11/18; H02P 7/24

(52) U.S. Cl. 318/139

(57) ABSTRACT

A system and methods for controlling an electric motor in an electric vehicle. The system includes a battery management system and a motor controller. The battery management system monitors output voltage of each individual cell unit in a battery pack with a plurality of cell units and generates a state signal and a count value according to the monitored output voltages. The motor controller receives the state signal and the count value from the battery management system and controls the output current to the electrical motor. The battery management system generates the state signal in a first state if none of the monitored output voltages is below a predefined voltage for longer than a predefined period. The battery management system increases the count value each time a monitored output voltage drops below the predefined voltage. The cell units in the battery pack are protected by the battery management system.

### RELATED APPLICATIONS

This application claims priority to Chinese Patent Application No. 201110204408.7, titled “Control System and Control Method for Electric Bicycle,” filed on Jul. 18, 2011, with the State Intellectual Property Office of the People's Republic of China.

### BACKGROUND

Electric bicycle is an environmental-friendly and relatively cheap vehicle, and is becoming more and more popular. A battery for powering the electric bicycle usually includes multiple cell units coupled in series or in parallel. Each cell unit outputs an output voltage, e.g. 2 V. The cell units are packaged into a battery pack and installed in the electric bicycle, and thus a higher voltage, e.g. 36 V, 48V, or 72 V, is provided to drive the electric bicycle. The battery can be, but is not limited to, a lithium battery, a lead-acid battery, a nickel-hydrogen battery, or other rechargeable batteries.

As a core component for battery protection and battery management, a battery management system (BMS) ensures that the battery is utilized not only safely but also fully. As a bridge between the battery and a motorist of the electric bicycle, the BMS plays a critical role in the performance of the electric bicycle. The BMS monitors the state of each cell unit in real time and also manages the battery pack intelligently so as to avoid unrecoverable damage and even battery explosion under abnormal conditions. The state of cell units includes voltages, currents, temperatures of the cell units, and so on. The abnormal conditions include over charge, over discharge, over-heating, and so on.

As a power equipment of the electric bicycle, a motor converts electrical energy into mechanical energy to drive the electric bicycle. The motor controller is operable for controlling the motor and providing other functions such as alarm generation and meter display.

FIG.1 illustrates an example of a conventional control system 100 for an electric vehicle, e.g. electric bicycle. The control system 100 includes a battery management system (BMS) 102 and a motor controller 106. The BMS 102 monitors and controls a battery pack 104. The battery pack 104 includes multiple cell units. Each cell unit outputs an output voltage according to its output capacity. The BMS 102 monitors output voltages of each cell unit in the battery pack 104. A control instruction from an external source (not shown) is sent to the motor controller 206 when the electric bicycle is started. The motor controller 106 includes a micro controlling unit 110 and a power regulation module 112. The micro controlling unit 110 receives the control instruction and generates a control signal according to the control instruction. The control signal is transmitted to the power regulation module 112 to regulate a current delivered to the motor 108. The current delivered to the motor 108 is determined by the control instruction.

When an electric bicycle is in operation, a discharge current of the battery pack 104 is proportional to the current delivered to the motor 108. The discharge current of the battery pack 104 may vary according to different driving conditions and the output voltages drop as the current of the battery pack 104 discharges from the battery pack 104. A decreasing rate of an output voltage indicates a reduction of the output voltage per unit time. A decreasing rate of an output capacity indicates a reduction of the output capacity per unit time. The greater the discharge current is, the greater a decreasing rate of each output voltage is, and the greater a decreasing rate of each output capacity is. Due to the chemical property of the cell unit, the output voltage drops to a transient voltage after the discharging process, and then increases to a steady voltage gradually if the discharge current of the battery pack 104 is cut off or dropped greatly. A voltage increment equals to the steady voltage minus the transient voltage. The greater the decreasing rate of the output voltage is, the greater the voltage increment is. For example, the current to drive the motor 108 is relatively small if the electric bicycle drives on a horizontal road with a constant speed. The decreasing rate of an output voltage is relatively small, e.g. the output voltage drops from 2.2 V to a transient voltage 2 V after 30 minutes. And then, the current to drive the motor 108 is cut off when the electric bicycle stops. The output voltage increases to a steady voltage 2.05 V gradually. The voltage increment is 0.05 V. In another condition, the current to drive the motor 108 is relatively large if the electric bicycle drives uphill. The decreasing rate of the output voltage is relatively large, e.g. the output voltage drops from 2.2 V to a transient voltage 1.8 V after 30 minutes. And then, the current to drive the motor 108 is cut off when the electric bicycle stops. The output voltage increases to a steady voltage 2 V gradually. The voltage increment is 0.2 V. The output voltage continues to drop below 2 V if the electric bicycle restarts. As shown, the output voltage varies in different forms under different driving conditions. Therefore, the output voltage may drop below a voltage level several times during the discharging process. The transient voltage cannot indicate the output capacity of the cell unit. Only the steady voltage can indicate the output capacity of the cell unit. Because the output voltage changes dynamically, the BMS cannot use the output voltage as an indicator for the output capacity of a cell unit.

Due to the chemical property of the cell unit, the battery pack 104 may be damaged if the output capacity drops to a very low level, which is called as over discharge. Therefore, the output capacity should be ensured to be greater than a predefined output capacity level to protect the battery pack 104. If the motorist of the electric bicycle executes an improper operation while the output capacity drops below a predefined output capacity level, an improper control instruction is sent to the motor controller 206, such that the battery pack will be damaged. The life of the battery pack 104 may be shortened because of improper operation when the output capacity drops below the predefined output capacity level. Therefore, it is needed an apparatus for protecting the battery pack 104 against over discharge when a battery is being discharged and it is to such apparatus the present invention is directed.

### SUMMARY

Embodiments of the invention provide systems and methods for controlling an electric vehicle. In one embodiment, a system, for controlling an output current to an electrical motor, includes a battery management system and a motor controller. The battery management system monitors output voltage of each individual cell unit in a battery pack with a plurality of cell units and generates a state signal and a count value according to the monitored output voltages. The motor controller receives the state signal and the count value from the battery management system and controls the output current to the electrical motor. The battery management system generates the state signal in a first state if none of the monitored output voltages is below a predefined voltage for a period longer than a predefined period. The battery management system increases the count value each time a monitored output voltage drops below the predefined voltage.

In another embodiment, a battery management system in an electric vehicle, the electric vehicle having a battery with a plurality of cell units, includes a monitoring unit and a counter. The monitoring unit monitors output voltages of each cell unit in the battery, generates a trigger signal if one of the output voltages drops below a predefined voltage, generates a state signal with a first state if none of the output voltages is below the predefined voltage for a predefined time period, and generates a state signal with a second state if one of the output voltages is below the predefined voltage for the predefined time period. The counter receives the trigger signal from the monitoring unit and generates a count value according to the trigger signal. The count value indicates a number of times that the output voltages from any of the plurality of cell units drop below the predefined voltage. A motor controller in the electric vehicle controls a motor according to the count value and the state signal.

In yet another embodiment, a method for controlling an electrical current delivered by a battery with a plurality of cell units to an electric vehicle, includes monitoring output voltages from the plurality cell units in the battery by a battery management system, generating a trigger signal if one of the output voltages drops below a predefined voltage by the battery management system, generating a count value indicating a number of times that the output voltages drop below the predefined voltage according to the trigger signal by the battery management system, generating a state signal with a first state by the battery management system if none of the output voltages is below the predefined voltage for a predefined time period, generating a state signal with a second state by the battery management system if one of the output voltages is below the predefined voltage for the predefined time period, receiving the state signal and the count value by a motor controller, and determining a maximum allowable current delivered to an electrical motor powering the electric vehicle according to the state signal and the count value by the motor controller.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates an example of a conventional control system for controlling an electric bicycle.

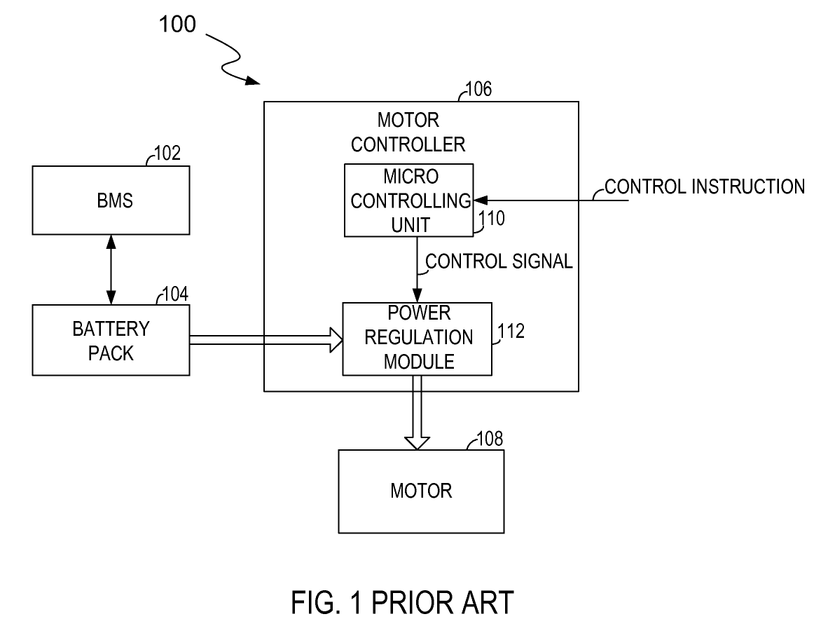

FIG. 2 illustrates an example of a control system for controlling an electric bicycle, in accordance with one embodiment of the present invention.

FIG. 3 illustrates an example of a BMS in FIG. 2, in accordance with one embodiment of the present invention.

FIG. 4 illustrates a flowchart of a method for controlling an electric bicycle equipped with the control system in FIG. 2, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

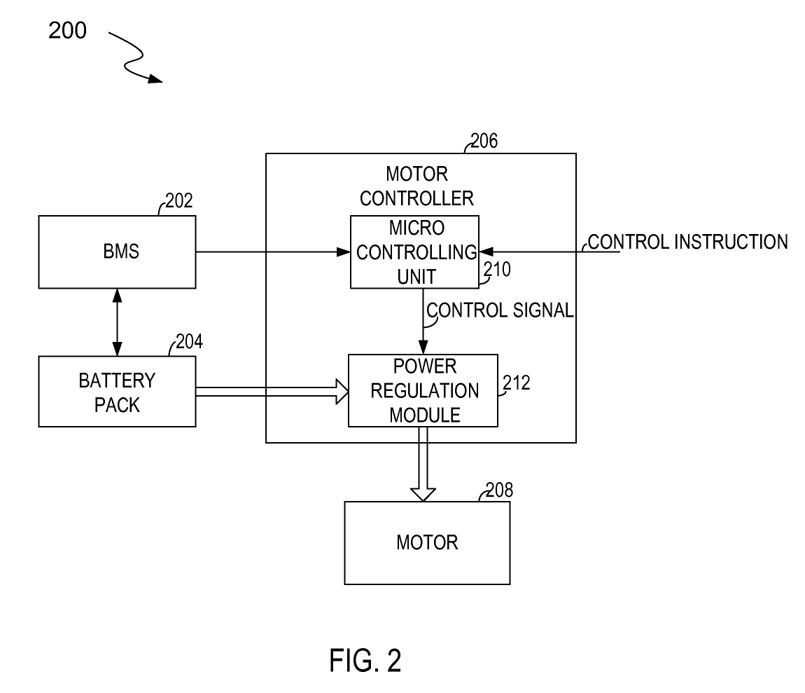

FIG. 2 illustrates an example of a control system 200 for controlling an electric vehicle, e.g. electric bicycle, in accordance with one embodiment of the present invention. The control system 200 includes a battery management system (BMS) 202 for managing a battery pack 204, and a motor controller 206 coupled to the BMS 202. The battery pack 204 includes multiple cell units for powering a motor 208 through the motor controller 206. Each cell unit outputs an output voltage according to its output capacity. The BMS 202 monitors output voltages of each cell unit in the battery pack 204 and outputs a count value and a state signal to the motor controller 206 based on the output voltages received from all the cell units in the battery pack 204. The count value is generated based on the voltage level of the output voltages and indicates a number of times that the output voltages drop below a predefined voltage. The state signal can be in a first state if none of the output voltages monitored by the BMS 202 is below the predefined voltage for a predefined time period, and the state signal can be in a second state if one of the output voltages is below the predefined voltage for the predefined time period. The motor controller 206 includes a micro controlling unit 210 and a power regulation module 212. The micro controlling unit 210 receives the state signal and the count value from the BMS 202 and generates a control signal according to the state signal, the count value, and a control instruction received from an external source (not shown). The control signal is transmitted from the micro controlling unit 210 to the power regulation module 212. The power regulation module 212 regulates a current delivered to the motor 208 according to the control signal. The current delivered to the motor 208 is limited by a maximum allowable current which is set by the motor controller according to the state signal and the count value.

In operation, the BMS 202 monitors the output voltages of each cell unit. The state signal generated by the BMS 202 remains in the first state and the count value generated by the BMS 202 is 0 if each output voltage remains above the predefined voltage. As the battery pack 204 discharges a current to drive the electrical motor 208, the output capacities of the cell units in the battery pack 204 drop gradually. Some cell units may become unbalanced, which causes the decreasing rates of the output voltages of the cell units (mentioned in the background) different from each other. As consequence, the output voltages from some cell units may drop below the predefined voltage faster than others.

The count value indicates how many times an output voltage from any one of the cell units drops below the predefined voltage. For example, assume the battery pack 204 includes a first cell unit cell-1 and a second cell unit cell-2, both cell units are monitored by the BMS 202. During the discharge of the battery pack, if the output voltage of the first cell unit cell-1 drops below the predefined voltage once while the output voltage of the second cell unit cell-2 remains above the predefined voltage, because the first cell unit cell-1 may have a different dropping rate than the second sell unit cell-2, then the count value generated by the BMS 202 is 1. If the electric bicycle stops and the battery pack 204 stops outputting a current, the output voltage of the first cell unit cell-1 and the output voltage of the second cell unit cell-2 may increase due to the chemical property of each cell unit, and the output voltage of the first cell unit cell-1 may increase above the predefined voltage again, such that the output voltage of the first cell unit cell-1 and the output voltage of the second cell unit cell-2 are both above the predefined voltage again. The state signal remains in the first state if none of the output voltages has dropped below the predefined voltage for a time period that is longer than the predefined time period. If the electric bicycle resumes moving, the output capacity of the first cell unit cell-1 and the output capacity of the second cell unit cell-2 will drop again, and both of the output voltage of the first cell unit cell-1 and the output voltage of the first cell unit cell-2 may drop below the predefined voltage. Thus, the output voltage of the first cell unit cell-1 drops below the predefined voltage twice while the output voltage of the second cell unit cell-2 drops below the predefined voltage once, and the count value increases to 3. Therefore, the greater the count value is, the smaller the output capacity is because the count value reflects how many times the output voltages have dropped below a redefined level, which is an indication of decreasing output capacity of the cell unit. If the electric bicycle continues moving, the output capacity of the first cell unit cell-1 and the output capacity of the second cell unit cell-2 will drop further, and the output voltage of the first cell unit cell-1 or the output voltage of the first cell unit cell-2 may not be able to recover to above the predefined voltage again. The BMS 206 generates the state signal with the second state if one of the output voltages is below the predefined voltage for the predefined time period.

Due to the chemical property of the cell unit, the battery pack 204 may be damaged if the output capacity drops to a very low level. Therefore, the output capacity should be maintained to above a predefined output capacity level to protect the battery pack 104. By setting appropriate levels of the predefined voltage and the predefined time period, the state signal with the second state can be an indicator for one or more output capacities are close to the predefined output capacity level. Therefore, to protect the battery pack 204, the motor controller 206 sets the maximum allowable current, which is adjusted to a lowest level, e.g. 0, when the state signal is in the second state.

When an electric bicycle is in operation, the output voltages from the cell units in the battery pack vary according to different driving conditions. For example, when an output voltage of a cell unit drops below the predefined voltage in time T1, the output voltage may not be able to recover to above the predefined voltage again. In this condition, the battery pack 204 continues to discharge and the BMS monitors the output voltages from the battery pack 204 and will change the state signal to the second state when the output voltage of the cell unit drops below the predefined voltage for the predefined time period. The discharge current from the battery pack 204 will be cut off when the state signal is changed to the second state in time T2. The battery pack 204 continues to discharge from the time T1 to the time T2 for the predefined time period. The battery pack 204 may be damaged if the output capacity drops below the predefined output capacity level. A decreasing rate of the output capacity indicates a reduction of the output capacity per unit time. During the predefined time period from the time T1 to the time T2, the smaller the discharging current is and the smaller a decreasing rate of the output capacity is, the smaller a possibility of cell damage will be. Therefore, the motor controller 206 needs to adjust the maximum allowable current to a lower level when one output voltage from one of the cell units in the battery pack drops below the predefined voltage and the count value increases from 0 to 1. As mentioned before, the greater the count value is, the smaller the output capacity is. The output capacity drops gradually and gets closer to the predefined output capacity level as the count value increases. As mentioned before, during the predefined time period, the smaller the discharging current is and the smaller a decreasing rate of the output capacity is, the smaller a possibility of cell damage will be. Therefore, to protect the battery pack 204, the motor controller 206 sets the maximum allowable current to a smaller value when the state signal is in the first state and the count value increases.

In another example, assume that the count value is CV, the maximum allowable current of the motor 208 is Iₗᵢₘᵢₜ, and a predefined current level is Iₘₐₓ, thus the Iₗᵢₘᵢₜ equals to 100% Iₘₐₓ when the state signal in the first state and the CV equals 0. The Iₗᵢₘᵢₜ is set to to 80% Iₘₐₓ when the state signal in the first state and the CV equals 1, and the Iₗᵢₘᵢₜ is set to 60% Iₘₐₓ when the state signal in the first state and the CV equals 2. The Iₗᵢₘᵢₜ is set to 40% Iₘₐₓ when the state signal in the first state and the CV equals 3, and the Iₗᵢₘᵢₜ is set to 0 or 10% Iₘₐₓ when the state signal in the second state. Advantageously, the maximum allowable current is adjusted by the motor controller 206 according to output capacities of each cell unit. The smaller the maximum allowable current is and the smaller the decreasing rate of the output capacity is, the smaller the possibility of cell damage is. The battery pack is protected effectively by adjusting the maximum allowable current.

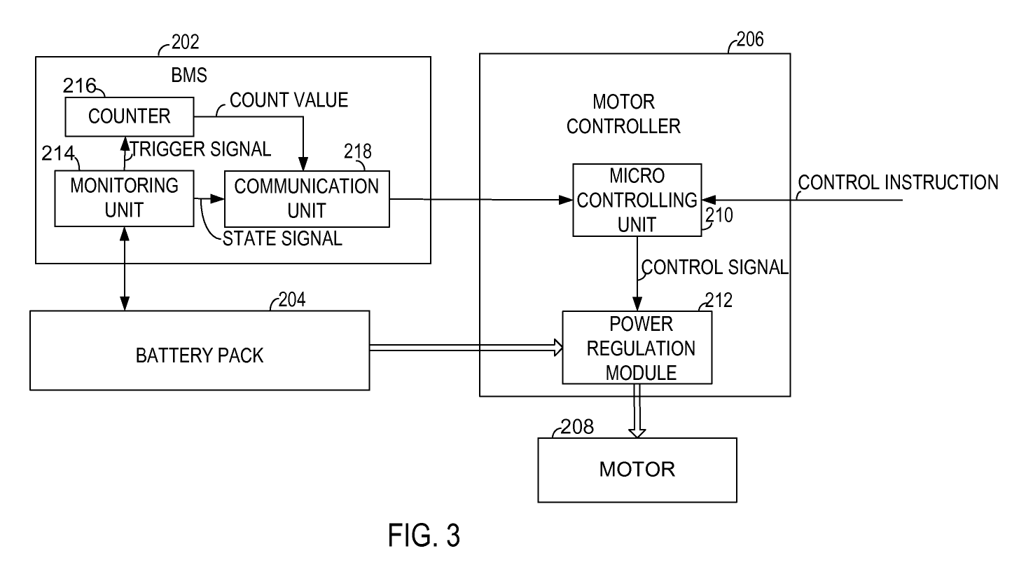

FIG. 3 illustrates an example of a BMS 202 in FIG. 2, in accordance with one embodiment of the present invention. The BMS 202 includes a monitoring unit 214, a counter 216, and a communication unit 218. The monitoring unit 214 monitors output voltages of each cell unit, and generates a trigger signal to the counter 216 if one of the output voltages drops below the predefined voltage. The monitoring unit 214 also generates the state signal with the first state if none of the output voltages is below the predefined voltage for the predefined time period, and generates the state signal with the second state if one of the output voltages is below the predefined voltage for the predefined time period. The counter 216 receives the trigger signal from the monitoring unit 214 and generates the count value to indicate the number of times that a output voltage from each cell unit inside the battery pack 204 drops below the predefined voltage based on the trigger signal. The count value is transmitted from the counter 216 to the communication unit 218, and the state signal is transmitted from the monitoring unit 214 to the communication unit 218. Then, the count value and the state signal are transmitted from the communication unit 218 to the motor controller 206 to determine the maximum allowable current of the motor in the electric bicycle.

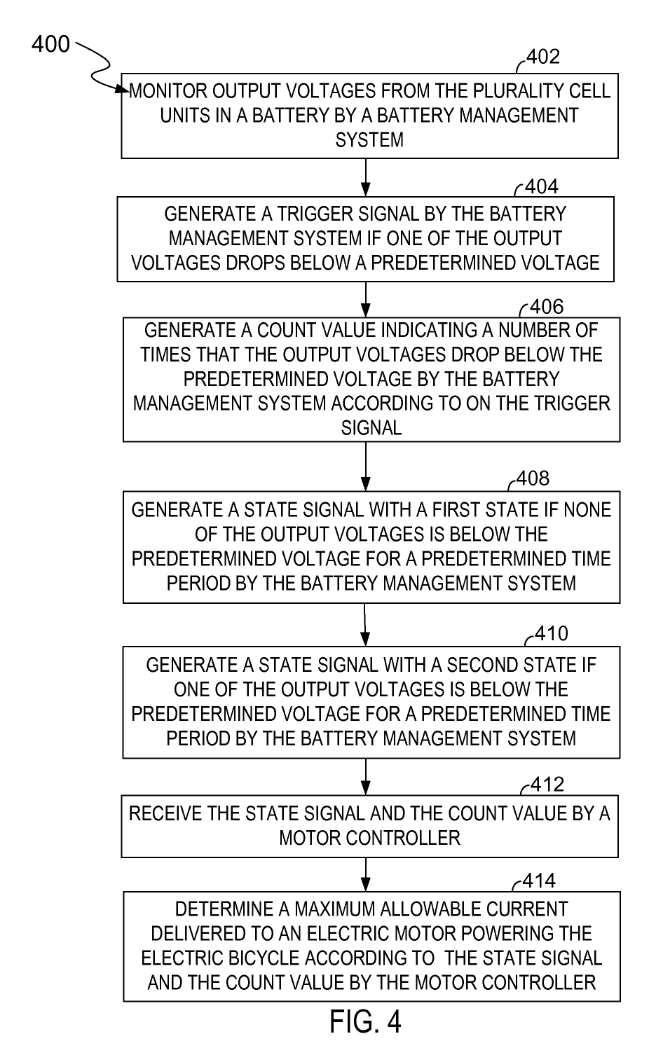

FIG. 4 illustrates a flowchart 400 of a method for controlling an electrical current delivered by a battery with a plurality of cell units to an electric bicycle equipped with the control system 200 in FIG. 2, in accordance with one embodiment of the present invention. FIG. 4 is described in combination with FIG. 2. A BMS monitors output voltages from the plurality cell units in the battery, step 402, and generates a trigger signal if one of the output voltages drops below a predefined voltage, step 404. The BMS generates a count value indicating a number of times that the output voltages drop below the predefined voltage based on the trigger signal, step 406, and generates a state signal with a first state if none of the output voltages is below the predefined voltage for a predefined time period, step 408. The BMS generates a state signal with a second state if one of the output voltages is below the predefined voltage for the predefined time period, step 410. A motor controller receives the state signal and the count value, step 412, and determines a maximum allowable current delivered to an electrical motor powering the electric bicycle according to the state signal and the count value, step 414.

Accordingly, the present invention provides a control system and a control method for controlling an electric bicycle. A BMS in the control system generates a state signal and a count value based on the output voltage of each cell unit, and transmits the state signal and the count value to a motor controller to regulate a maximum allowable current of a motor. The state signal and the count value indicate different battery states in different driving conditions, and thus the maximum allowable current is adjusted according to different battery states, the cell units are protected and the life time of the battery pack is extended.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A system, for controlling an output current to an electrical motor, comprising:
a battery management system for monitoring output voltage of each individual cell unit in a battery pack with a plurality of cell units and for generating a state signal and a count value according to the monitored output voltages; and
a motor controller for receiving the state signal and the count value from the battery management system and for controlling the output current to the electrical motor,
wherein the battery management system generates the state signal in a first state if none of the monitored output voltages is below a predefined voltage for a time period longer than a predefined time period, and the battery management system increases the count value each time a monitored output voltage drops below the predefined voltage.

2. The system of claim 1, wherein the battery management system generates the state signal in a second state if one of the monitored output voltages is below the predefined voltage for a time period longer than the predefined time period.

3. The system of claim 2, wherein the motor controller sets a maximum allowable current for the output current.

4. The system of claim 3, wherein the motor controller selects a level of the maximum allowable current from a plurality of predefined current levels according to the state signal and the counter value.

5. The system of claim 4, wherein if the state signal is in the first state and if the count value increases, the motor controller decreases the maximum allowable current.

6. The system of claim 4, wherein if the state signal is in the second state, the maximum allowable current has a smallest level among the plurality of predefined current levels.

7. The system of claim 2, wherein the battery management system further comprises a monitoring unit for monitoring output voltage of individual cell unit in a battery pack, generating a trigger signal if one of the output voltages drops below the predefined voltage, generating the state signal in the first state if none of the output voltages is below the predefined voltage for the predefined time period, and generating the state signal in the second state if one of the output voltages is below the predefined voltage for the predefined time period.

8. The system of claim 7, wherein the battery management system further comprises a counter for generating the count value according to the trigger signal.

9. The system of claim 7, wherein the battery management system further comprises a communication module for transmitting the state signal and the count value to the motor controller.

10. A battery management system in an electric vehicle, the electric vehicle having a battery with a plurality of cell units, comprising:
a monitoring unit that monitors output voltages of each cell unit in the battery, generates a trigger signal if one of the output voltages drops below a predefined voltage, generates a state signal with a first state if none of the output voltages is below the predefined voltage for a predefined time period, and generates a state signal with a second state if one of the output voltages is below the predefined voltage for the predefined time period; and
a counter that receives the trigger signal from the monitoring unit and generates a count value according to the trigger signal,
wherein the count value indicates a number of times that the output voltages from any of the plurality of cell units drop below the predefined voltage,
wherein a motor controller in the electric vehicle controls a motor according to the count value and the state signal.

11. The battery management system of claim 10, wherein the battery management system further comprises a communication module that transmits the state signal and the count value to a motor controller in the electric vehicle.

12. A method for controlling an electrical current delivered by a battery with a plurality of cell units to an electric vehicle, comprises:
monitoring, by a battery management system, output voltages from the plurality cell units in the battery;
generating, by the battery management system, a trigger signal if one of the output voltages drops below a predefined voltage;
generating, by the battery management system, a count value indicating a number of times that the output voltages drop below the predefined voltage according to the trigger signal;
generating, by the battery management system, a state signal with a first state if none of the output voltages is below the predefined voltage for a predefined time period;
generating, by the battery management system, a state signal with a second state if one of the output voltages is below the predefined voltage for the predefined time period;
receiving, by a motor controller, the state signal and the count value; and
determining, by the motor controller, a maximum allowable current delivered to an electrical motor powering the electric vehicle according to the state signal and the count value.

13. The method of claim 12, further comprising:
decreasing, by the motor controller, the maximum allowable current if the count value increases while the state signal is in the first state.

14. The method of claim 12, further comprising:
adjusting, by the motor controller, the maximum allowable current when the state signal is in the second state to be lower than the maximum allowable current when the state signal is in the first state.
